(19) United States
(12) Patent Application Publication
(10) Pub. No.: US 2008/0161941 A1
(43) Pub. Date: Jul. 3, 2008

(54) GRAPH-THEORETIC TECHNIQUE OF ANALYZING AND OPTIMIZING POLICY DEPLOYMENT

(75) Inventors: John C. Strassner, North Barrington, IL (US); David L. Raymer, Watauga, TX (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: Motorola, Inc., Schaumburg, IL (US)

(21) Appl. No.: 11/618,125

(22) Filed: Dec. 29, 2006

(51) Int. Cl. G05B 17/00

(52) U.S. Cl. 700/29

(57) ABSTRACT

A method and a device for managing state changes (Init, Run, Suspend, Resume, End) of a managed entity (302) includes a memory (906) and a processor (904) adapted to represent each state change of a managed entity (302) as a separate node (1-5) in a graph (300), represent a state transition as an edge (Eᵢⱼ) connecting a first node with a first state value to a second node with a second state value, and determine a cost (C) of each edge (Eᵢⱼ) that is part of a set of edges (E) that form at least two paths connecting the first node and the second by applying at least one policy (P) to each edge (Eᵢⱼ), the first and second nodes representing an initial and a final state change of the managed entity (302).

### FIELD OF THE INVENTION

This invention relates in general to policy management, and more particularly to structuring and reordering policies to adapt to changing business needs and environmental conditions using graph-theoretic techniques.

### BACKGROUND OF THE INVENTION

Large systems can have a large number of policies that can interact in many different ways. While orchestrating the behavior of a system can be guided by policies, changing business needs and environmental conditions change the policies used and their order of application in unforeseen ways.

There are currently no preferred ways of analyzing sets of policies to determine: if the order of application of policies is correct (let alone best); if the states visited by the set of policies are allowed (let alone optimal); what are the dependencies between each of the policies (including pre- and post-conditions and invariants); how the set of policies should change when business goals change; and how the set of policies should change when the needs of the users and environmental conditions change.

The currently-known art defines a static set of conditions that define when policy is applied. However, static conditions lead to at least four important limitations in the art. They are:
1. inability to reorder policies to take into account changing business needs or environmental conditions (e.g., if a reconfiguration requires 3 separate steps that involve 3 different state changes, three different policies may be needed and the policies might need to be reordered to suit current business needs and/or environmental conditions);
2. inability to adjust the applicability of a given policy (without changing its structure or content) to account for its varying relevance (e.g., as a function of changing context or business rules);
3. inability to choose the best set of policies, among a set of applicable policies, that must be applied in a particular order, to move the system (or a component) to a new desired state; and
4. inability to accommodate changing contexts.

Therefore, a need exists to overcome the problems with the prior art as discussed above.

### SUMMARY OF THE INVENTION

A method and system are disclosed for managing state changes of a managed entity, which includes representing each state change of a managed entity as a separate node in a graph, representing a state transition as an edge connecting a first node with a first state value to a second node with a second state value, and then determining a cost of each edge that is part of a set of edges that form at least two paths connecting the first node and the second by applying at least one policy to each edge, the first and second nodes representing an initial and a final state change of the managed entity.

In accordance with an added feature of the invention, a total cost of a first one of the at least two paths is compared to a total cost of a second one of the at least two paths and the one of the at least two paths that has a lowest cost is selected.

In accordance with an additional feature of the invention, a first policy is related to at least one second policy so that at least one of creating, invoking, deleting, adding, stopping and changing the second policy affects the first policy by causing it to assign a different cost to the set of edges that it governs.

In accordance with yet another feature of the invention, a cost of each edge is determined based at least in part on the weight which has been set for that edge.

In accordance with yet a further feature of the invention, a policy is invoked and the permissibility of a state change is determined by utilizing the policy.

In accordance with still a further feature of the invention, the cost of an edge is set to a value that removes it from a class of best paths in response to a state change not being allowed by the policy.

In accordance with an additional feature of the invention, a method for managing the connectivity and communication between nodes of a graph includes representing each state change of a managed entity as a separate node in a graph, representing at least one of the separate nodes as one of either a multigraph, a hypergraph, or a pseudograph of different states of a set of managed entities, and then representing a state transition as an edge connecting a first of the separate nodes having a first state value to a second of the separate nodes having a second state value. The method also includes determining a cost of each edge that is part of a set of edges that form at least two paths connecting the first node and the second by applying at least one policy to each edge, the first and second nodes representing an initial and a final state change of the managed entity.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is a block diagram illustrating a policy-based system, according to an embodiment of the present invention;

FIG. 2 is a flowchart depicting the entire graph construction logic process, according to an embodiment of the present invention;

FIG. 3 is a process flow diagram of entity management represented using a graph, according to an embodiment of the present invention;

FIG. 4 shows the graph of FIG. 3 with policies applied, according to an embodiment of the present invention;

FIG. 5 shows the graph of FIG. 3 with related policies applied, according to an embodiment of the present invention;

FIG. 6 shows the graph of FIG. 3 with multiple related policies applied, according to an embodiment of the present invention;

FIG. 7 shows the graph of FIG. 3 with a policies controlling the permissibility of a path, according to an embodiment of the present invention;

FIG. 8 shows a diagram suitable for resource or service management represented as a graph, with each node in the graph representing the state of a managed entity, with a pseudograph depicting the management of internal states of one of the nodes, according to an embodiment of the present invention; and

FIG. 9 is a high level block diagram of the policy server of FIG. 2, according to an embodiment of the present invention.

FIG. 10a shows an exemplary Resource Graph, and FIG. 10b shows the overlay of a set of Service paths on said Resource Graph.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The present invention solves the problem of structuring and reordering policies to adapt to changing business needs and environmental conditions by representing a set of applicable policies, according to one embodiment, as weighting functions that are applied to a graph of resource and/or service states. This graph lends itself to visual (e.g., by humans) and machine analysis, enabling different scenarios to be simulated by taking different “paths” through the graph. The graph not only provides possible reordering solutions, it also lends itself for other uses, such as optimizing a given solution. Additionally, the graph is enabled by many different graph-optimization algorithms available in the art. Hence, one embodiment of the present invention uses an established technology—graph theory—for policy analysis.

According to certain embodiments of the present invention, “weights” are assigned to particular policies to better reflect the changing needs of the user, changing environmental conditions, and/or capabilities and/or restrictions imposed by a change of context. Significantly, this means that the graph structure does not have to change—only the weights of the edges change—enabling this invention to be used for various game-theoretic and “what-if” analyses. This also enables different solutions to be realized as a function of changing metrics for the same condition (e.g., different weights can be assigned to different resources and/or services that are represented in the graph, and the user can see how these weights change the nature of the graph), a valuable optimization function that the known art cannot currently achieve.

Furthermore, in accordance with certain embodiments of the present invention, a “best” set of policies is found using the policy weights and any number of available graph-optimization techniques. “Best” is defined by the set of metrics that are optimized by the graph theoretic techniques.

Additionally, the present invention is able to associate the governance offered by a policy with a changing weighting factor to accommodate changing contexts, through use of the Directory Enabled Networks-new generation (DEN-ng) policy model as described in Policy-Based Network Management, John C. Strassner, Morgan Kaufmann Publishers, 2004—the contents of which are hereby incorporated by reference, which already relates context to policies; a simple extension enables this to be related to the graph of all policies. In addition, the teachings of Strassner, J., and Reilly, J., Introduction to the SID, TMW University Program, May 2006; J. Gross, Graph Theory and its Applications, ISBN 158488505X; and R. Diestel, Graph Theory, 3rd edition, Springer Graduate Texts in Mathematics series, ISBN 3540261834 are also incorporated herein by reference.

Policy System

FIG. 1 illustrates a simple policy-based system 100 according to an embodiment of the present invention. Note that the simple nature of the example system shown in FIG. 1 does not constrain the present invention, which is capable of enhancing the operation of policy-based systems of large size and great complexity.

In FIG. 1, a policy control and editing system 101 creates, receives, edits, and maintains policy rules. A policy server 102 actively manages the policy rules governing the operation of the system. A policy system bus 103 connects the policy system components and connects the policy system to the managed network 104. A first Policy Execution Point (PEP) 105 implements policy actions directed toward a first managed entity 106. In this example case, the first PEP 105 and the first managed entity 106 are separate and communicate via the policy system bus 103 and the network 104 as shown by the broken line 116.

A second PEP 107, implements policy actions (not shown) directed toward a second managed entity 108. In this case, the second PEP 107 is co-located within its corresponding managed entity 108.

The policy server 102 includes several components. A conflict resolution component 109 works to resolve conflicts between policy rules. A policy conflict occurs when the conditions of two or more policy rules that apply to the same set of managed objects are simultaneously satisfied, but the actions of two or more of these policy rules conflict with each other. One or more Policy Decision Points (PDPs) 110₁-110ₘ evaluate policy conditions that are targeted at specific domains, such as QoS and security. This addresses the most common existing and legacy deployments of policy management, wherein separate policy control is assigned to different functions to be managed. However, this should not limit the present invention, in that a single Policy Server 602′ (not shown) could be constructed using the mechanisms described in this invention to manage a plurality of different functions. In accordance with one embodiment of the present invention, a performance rating component 112 maintains the ordered list of policy rules and their performance ratings. In other embodiments, the performance rating component 112 may apply specified thresholds to policy rule performance, selectively calling operator attention to policy rules according to their performance. In other embodiments, the performance rating component 112 may respond to requests for input from the conflict resolution component 109 to help resolve policy rule conflicts. A policy repository component 113 is provided within the policy server 102 to store the policy rules. PEPs 105, 107 request policy decisions from PDPs 110₁-110ₘ; one or more of these PDPs 610₁-610ₘ will then respond to the PEPs 605,607 with the requested policy decision.

The policy-based system 100, in accordance with one embodiment of the present invention, also includes a policy broker 114. The policy broker 114 controls how different policy servers 102 interact with each other and ensures that conflicts do not exist between the policy servers 102. The policy broker 114 also coordinates the application of different policy rules in different policy servers 102.

Graphing

The present invention, according to certain embodiments, provides a novel and efficient means to structure and reorder policies to adapt to changing business needs and environmental conditions by using graph-theoretic techniques. Embodiments of the present invention are applicable to an end-to-end service that is governed by a set of policies. The inventive process begins by defining a set of resources R={R₁, R₂, . . . , Rₘ} and services S={S₁, S₂, . . . , Sₙ} that represent the set of resources and services, respectively, that are to be governed by one or more policies. Next, a set of policies P={P₁, P₂, . . . , P_{z}} are defined that can be used to govern each of the resources and services in R and S.

An information model and/or data model(s) defines the characteristics and relationships of the Policies, Resources and Services in the system. In general, the Resource topology is first defined; then, the set of Services are overlaid on top of available Resources. This reflects the real-world dependency that Services cannot exist by themselves—they must instead be hosted or bound to available resources. This also enables this invention to take into account interruption of resource availability to services.

A graph of the system is then formed by first, representing the state changes of each of the resources and/or services (elements of R and/or S) as different nodes in the graph. Next, a cost of the connection between nodes as a set of edges is represented, where in general, a connection between Resources Rᵢ and Rⱼ (or Services Sᵢ and Sⱼ) is represented by Eᵢⱼ, and the set of all edges E is represented as E={E₁₁, E₁₂, . . . , E₁ⱼ, E₂₁, . . . , Eᵢⱼ}.

Next, each connection (represented by Eᵢⱼ) is associated with a cost, defined by any conventional means that is appropriate (called its conventional cost Cᵢⱼ). Each policy, Pₖ, where (k=1 . . . z), can be used to govern one or more of the edges, Eᵢⱼ, in the set E (if there is no such policy, then its cost is simply Cᵢⱼ); this then provides a new cost C(P^{k}ᵢⱼ), which represents the Cost, C, of the Edge Eᵢⱼ assigned by the Policy P^{k}. We will denote this new cost as Wₖ for convenience. Since one or more policies may affect the overall cost of the same edge, Eᵢⱼ, a set of such costs are defined for all policies, Pₖ, that affect a given edge Eᵢⱼ (denoted as Pᵢⱼ).

In order to connect two nodes i and j, the set of policies associated with the edge connecting the two nodes (e.g., Pᵢⱼ) is executed (i.e., the successful resolution of its actions are determined). The output of the executed policy, Pₖ, assigns a weighting function, Wₖ, where the value of the weighting function, Wₖ, is determined by the resolution of its actions (success or failure) and their metadata (e.g., the overall execution strategy of the policy, as defined in Policy-Based Network Management, for instance). In an embodiment of the present invention, the weight of an edge is set by using a parameterized function.

Therefore, the cost of the edge, Eᵢⱼ, can be defined (according to a particular application-specific execution strategy) as one of the following:
1. Wₖ∘Cᵢⱼ, where Wₖ is the cost of the Edge Eᵢⱼ assigned by the Policy Pₖ, ∘ is a mathematical function defined either by an administrator, metadata of the Policy Pₖ, or another Policy, and Cᵢⱼ is the traditional cost of the edge, Eᵢⱼ (note: if there are multiple Policies that affect the same Edge Eᵢⱼ, then another mathematical function, •, can be defined (again, either by the administrator, metadata, or another Policy), that determines how each weight of each policy is combined);
2. Wₖ, which represents the replacement of the conventional cost Cᵢⱼ with the new weighted policy cost of the Edge Eᵢⱼ (note: multiple Policies are handled as described above);
3. The conventional cost Cᵢⱼ, which means that the effect of the Policy was 1 (i.e., the edge was enabled by policy); or
4. 0, which means that the edge transition was not allowed (i.e., the edge was disabled by policy).

Therefore, in accordance with embodiments of the present invention, policies are used to enable or disable edge transitions. A weighting function, where the function can be a parameterized function, that assigns a new edge cost, is associated with each policy, which enables policy control of behavior exhibited by the graph. Specifically, the invention enables the cost of a connection between two nodes to be adjusted according to policy, which means that the graph can be re-purposed without changing any of its elements. As a result, the cost can be defined by one of the following:
1. A mathematical function using the conventional cost and the weighting function of a policy governing that connection (e.g., sum or product); this enables the same node to have different weights (and hence, different applicabilities) based on the particular Policy (or set of Policies) that is currently active.
2. The choice of either its conventional cost or the weighting function of a policy governing that connection; this enables the policy to override the normal cost of the edge.
3. The choice of either its conventional cost or 0 (i.e., not able to be traversed); this enables the policy to serve as an access control function that enables or disables an edge from being used.

As explained above, a Policy, Pₖ, can govern one or more edges. While there are many ways to determine the particular set of edges that Pₖ can govern, embodiments of the present invention use an information model and/or data model to do this because information and/or data models provide a standard set of relationships between a policy and the set of resources and services that it governs, and hence can be used in multi-vendor environments. Furthermore, knowledge from the information and/or data models can be augmented by ontological information, in order to provide more accurate and detailed graphs. An ontology is a formal, explicit specification of a shared, machine-readable vocabulary and meanings, in the form of various entities and relationships between them, to describe knowledge about the contents of one or more related subject domains throughout the life cycle of its existence. These entities and relationships are used to represent knowledge in the set of related subject domains. Formal refers to the fact that the ontology should be representable in a formal grammar. Explicit means that the entities and relationships used, and the constraints on their use, are precisely and unambiguously defined in a declarative language suitable for knowledge representation. Shared means that all users of an ontology will represent a concept using the same or equivalent set of entities and relationships. Subject domain refers to the content of the universe of discourse being represented by the ontology.

Additional detail can be easily added to the policies, resources and services that the information model and/or data models represents (i.e., the solution is “future-proofed”). In addition, code generation techniques can be applied to the information and/or data models, resulting in a more efficient and faster turn-around than other methods, such as hand-crafting code.

In accordance with a further feature of the present invention, the system can produce a ranking, according to one or more metrics, that provide recommendations on particular sets of policies to use, given the particular metrics; this enables the invention to adapt to changing user needs, environmental conditions, and changes to business objectives (which drive policies in DEN-ng) without changing the structure of the graph or the policies. This is done by adjusting the weighting functions of affected policies. It should be noted that all or a selected subset of policies can be simultaneously adjusted by controlling the input to their weighting function.

Embodiments of the present invention also define the applicability of a given policy (as well as the edge or set of edges that the policy governs) as a set of metrics (e.g., average availability, bandwidth, and so forth). The weighting function, Wₖ, takes these metrics into account and, as one or more of the metrics change, the output of the weighting function changes. This can be used as the cost of the edge, or as a multiplying factor to the conventional cost of the edge. Thus, optimizing the system behavior becomes a function of optimizing the graph at any given point in time for the particular combination of Policies and their weighted metrics.

The present invention provides an additional advantage of enabling what-if analyses, based on statistical and/or game-theoretic population of edge transitions of the graph, to be easily analyzed.

Process Flow

A process flowchart depicting the entire graph construction logic process, according to an embodiment of the present invention, is shown in FIG. 2. Policies are used to govern both Resources and Services. The process starts at step 200 and moves directly to step 202 where a graph of resources is defined by first locating all resources using any physical topological discovery algorithm; these are the nodes of the resource graph. The different connectivities between each node are determined using any logical topological discovery algorithm; these are the edges of the resource graph. This is shown in FIG. 10a.

Next, in step 204, the graph is enhanced with available services. Conceptually, this can be viewed as using the existing Resource Graph to define a set of nodes that will support the Service, as shown in FIG. 10b. Note in particular that not every node in the Resource Graph will be able to support a specific Service. In a following step, 206, a determination is made as to how to represent the overall graph. Examples of possible representations include a direct linked graph, a set of nested graphs, a set of pseudographs, and/or a set of hypergraphs, and others. The invention is not limited to any particular type of graph and can accommodate mixed types.

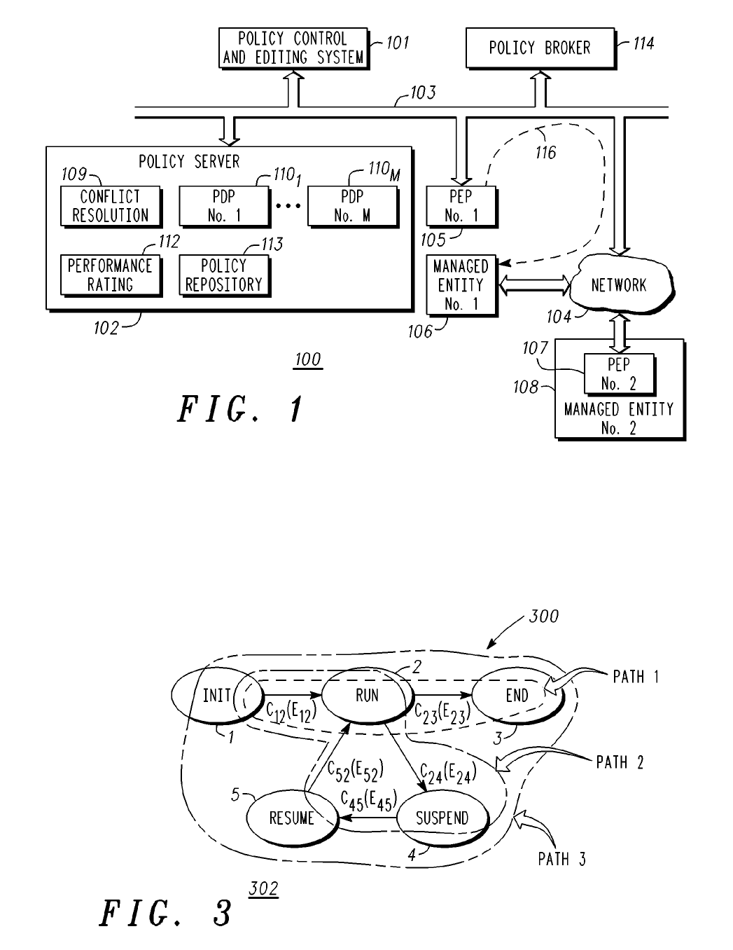

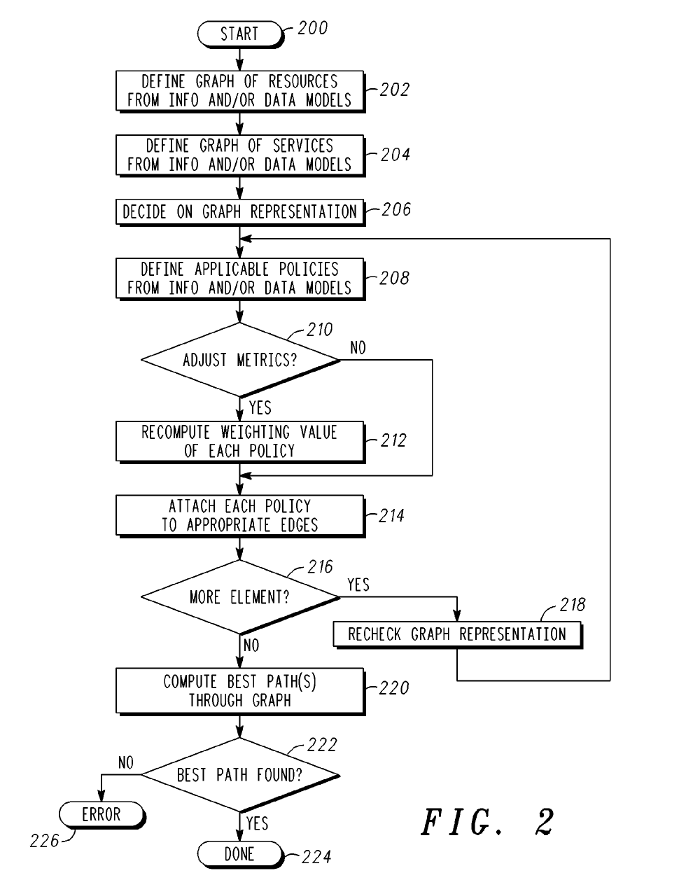

FIG. 3 shows an example process flow diagram of an exemplary application of the present invention used to create and mange a graph 300 representing the states of a managed entity 302. The graph 300 has five possible states for the same managed entity: Init, Run, End, Resume, and Suspend. These states collectively represent the “fictional behavior” of a managed entity, and are merely a few examples of the complete set of entity states. Each state change is represented as a node (1-5) in the graph 300. The transition from one state to another state is represented as one of 5 edges: E₁₂, E₂₃, E₂₄, E₄₅, and E₅₂. This type of graph is referred to as a “directed” graph, because each edge is directed (i.e., can only go one way). Mathematically speaking, it is ordered (i.e., the states are visited in a specific order). A cost, Cᵢⱼ, of each of the five edges is determined by traditional means. As should be clear from FIG. 3, there are three paths through the graph: E₁₂-E₂₃, E₁₂-E₂₄-E₄₅-E₅₂ . . . (i.e., it loops, never finishing), and E₁₂-E₂₄-E₄₅-E₅₂-E₂₃.

Note that the approach in steps 202 and 204 of first, defining resources and second, defining services, is an important one, as it mirrors the real-world constraints of any system. Services are inextricably bound to resources. The ability to optionally consider this alternative is important, as it has significant implications with respect to computational complexity (and hence, speed of decision-making) as well as the footprint of the system. This also enables the present invention to be used in systems in which the resource availability is fixed.

Next, in step 208, for each service, one or more policies are selected to govern it. This can be performed by examining associations in the information and data models between a given resource and/or service and the policies that could be applied to it. In short, if there is a direct association in the information model, then the policy is mandatory; if there is an indirect association, the data model will be examined—if instances exist, it is mandatory; if instances do not exist, then it is optional. If there is no association between policy and resource or service, then the policy does not apply.

Optionally, the information available from the information model and set of data models can be augmented with ontological information. Ontologies are used in this situation to provide additional semantics augmenting the knowledge available from the models. For example, information and data models define facts; ontologies can be used to reason about discovered facts. This enables policies to be managed and applied based on changing context.

Note that an advantage of using information and data models is that as the managed system changes in functionality, the models can be updated to reflect these changes, which in turn automatically updates relationships to policies; similarly, as policies are created in or removed from the system, they can be automatically attached to or detached from the existing services and resources of the system.

In step 210, for each possible scenario, zero or more metrics are adjusted in the policies governing the service. If one or more metrics are adjusted, then the weighting function of the policy is recomputed in step 212. The weighting function of the policy is a function of the effects that the set of actions that the policy has on the service or resource. Conceptually, each policy contains one or more actions, and each action can affect one or more properties of the service or resource, thereby affecting its state (as well as its behavior).

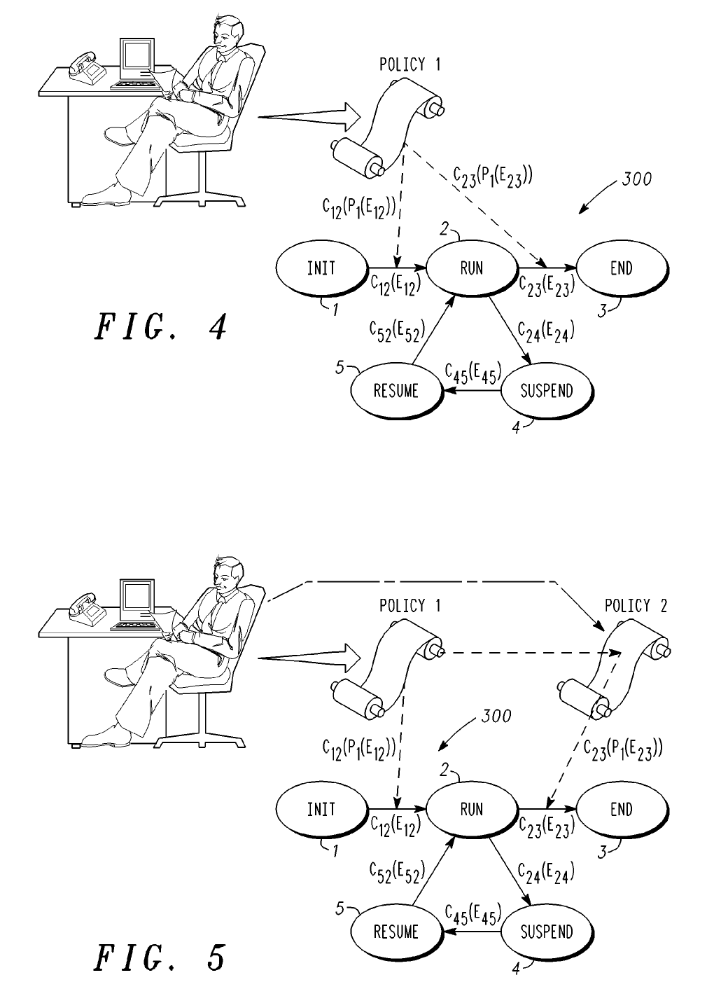

If, in step 210, no metrics need to be adjusted, the flow moves directly to step 214, where policies are associated with the appropriate edges in the graph to which the policy is to govern. For instance, FIG. 4 shows the graph 300 of FIG. 3 with a policy, Policy 1, applied to edge E₁₂ connecting nodes Init and Run, and to edge E₂₃ connecting nodes Run and End. From this simple graph, three important observations can be made: 1) Edges E₁₂ and E₂₃ form a path, from the Init Node 1 (source) to the End Node 3 (sink); 2) Policy 1 proposes two new costs, C₁₂(P₁(E₁₂)) and C₂₃(P₁(E₂₃)), for edge E₁₂ and edge E₂₃, respectively; and 3) Not all edges in the graph have to have a policy function applied to them. In this case, the cost of each edge that does not have a policy applied to it is the cost of that edge using the traditional method of computation (i.e., Cᵢⱼ). In the case where an edge does have one or more policy functions applied to it, policy may alter or override the traditional cost of the edge.

Each application will have its own requirements on how the characteristics and behavior of a given service or resource are optimized. This invention does not direct how an application has to interact with its services or resources; rather, it takes those functions into account in its weighting function. Hence, the invention does not prescribe the weighting function; rather, this invention defines the use of a weighting function that can be used with any application-specific approach by adjusting how the metrics are used. Four examples are:
1. Each action can be viewed as part of an overall weighted multiplier; hence, the weighting function value is the sum of the weight of each individual action;
2. The policy can make the cost of the edge infinite, effectively removing it from the graph (this represents the inability of a node to transition to a new state because of a policy violation);
3. Each action can be viewed as an equally weighted multiplier; hence, the weighting function value is the product of the weight of each individual action; and
4. The policy can enable or disable a particular edge from consideration in the graph (e.g., enabled means the weight is 1, which in turn means that the traditional cost of the edge is used; disabled means the weight is 0, which means the edge is not allowed to be used).

As stated above, policy can be used to control the state of the system. Since the weighting function of a policy affects the cost of an edge, embodiments of the present invention can also be used to define whether a state change is permissible or not (i.e., the lower the cost of an edge (as long as it is not 0), the more an edge is preferred; if the cost of an edge is greater than some threshold, then that edge will not be selected as a “best” choice of paths and will not be traversed). Two different types of states can be controlled in this manner: (1) the initial state change that triggers the application of policy, and (2) the subsequent state changes that occur due to the application of policy. Note that by adjusting the weighting, both reordering paths between a source and a destination as well as resolving conflicts can be achieved.

An example of enabling two edges while disabling a third is shown in FIG. 7. The disabling is performed, according to an embodiment of the present invention, by making the cost of the path so high that it will never be selected as a best path. In this way, a policy can manually steer a system to select a particular path (e.g., a set of reconfiguration actions to take) in order to arrive at a particular state. For instance, edges E₁₂ and E₂₃ are given reasonable cost values (weights) of 5 and 7, respectively, while edge E₂₄ is effectively disabled by receiving a weight of 1,000,000. Because the weight of edge E₂₄ is so high, it is virtually ensured of never being selected as a viable path.

Alternatively, the invention could be used to remove an edge from the graph completely. The advantage of removing the edge is that now it can never be taken. This method is even safer than raising the value of an edge, but is usually not done in graph applications.

Returning to FIG. 2, if more elements are found, step 216, the choice of graph representation (i.e., the entire graph or one or more subgraphs of the entire graph) is continually revisited in step 218 to ensure that it is optimal for the given graph. Once weights are attached to all edges of the graph, any appropriate graph optimization algorithm can be used to compute the best path in step 220. If the system determines that a best path is found in step 222, the flow moves to step 224 and ends.

Note that since this is a policy-based system, instead of throwing away all non-optimal paths, this invention will, in general, retain some percentage of these paths (for example, those whose cost is above a pre-determined ratio). This enables fast handover to a different policy when a resource and/or service fails. If a best path cannot be found, the process aborts and raises an error in step 226. If there are multiple best paths, then a conflict-detection algorithm must be run (such as our graph-theoretic conflict algorithm) to detect and resolve conflicts such that only one path will remain in the system; otherwise, if there is only one path, then the process has successfully completed.

In some situations, policies are related to each other. According to an embodiment of the present invention, a first policy can be related to at least one second policy so that a change to one or more of the second policies affects the first policy by causing it to assign a different cost to the edge or set of edges that it governs. For instance, as shown in FIG. 5, a second policy, Policy 2 is added to the graph 300 shown in FIGS. 3 and 4. Instead of having Policy 1 control the cost of edge E₂₃, policy 1 is rewritten so that when it executes, it will trigger Policy 2. Policy 2 is now responsible for determining the cost of edge E₂₃. The triggering of Policy 2 is not limited to Policy 1 executing or otherwise being invoked, but includes any possible function of Policy 1, such as deleting, editing, changing the attributes of, etc.

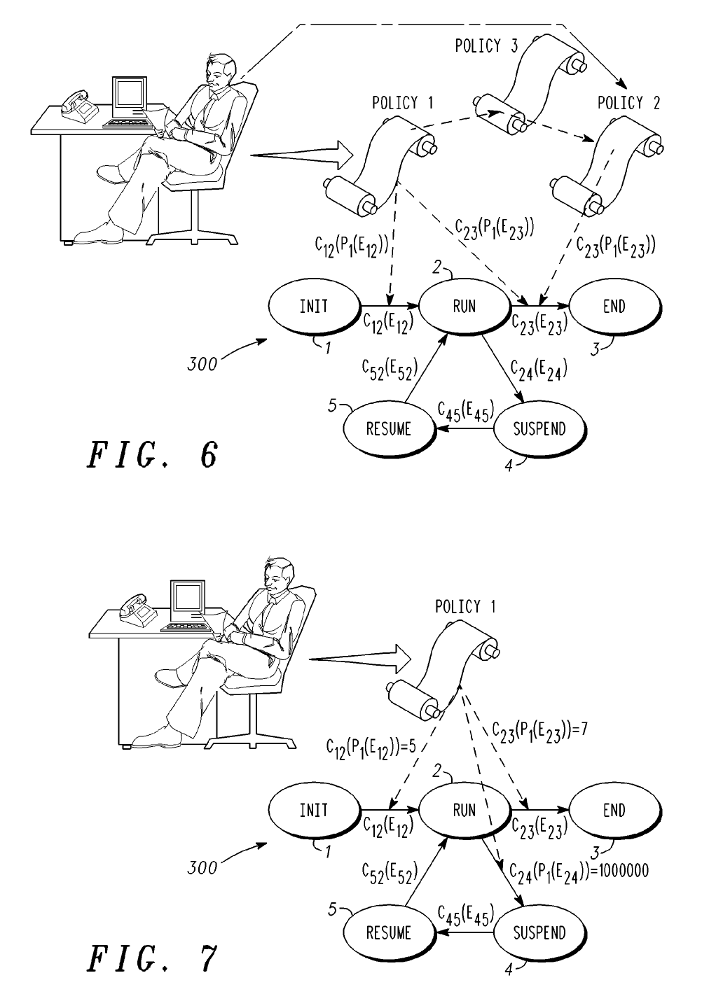

In some circumstances, as is shown in FIG. 6, two or more policies try to set the cost (or weight) of the same edge. In this situation, it is desirable to define a mathematical function that yields a single cost of that edge. For example, such a function can be C(P₁(E₂₃))*C(P₂(E₂₃)). Note that it is irrelevant if Policy 1 still determines the cost of edge E₁₂. The mathematical function used can be defined by any of the following as well as others: 1) the user; 2) metadata present in the one or more policies being combined (in this case, policies 1 and 2); or 3) by a third policy that is triggered when such a condition occurs.

In another embodiment of the present invention, where multiple policies are governing the same edges, as shown in FIG. 6, instead of combining the policies a selection is made between Policy 1 or Policy 2. The selection can be defined by the same methods as above.

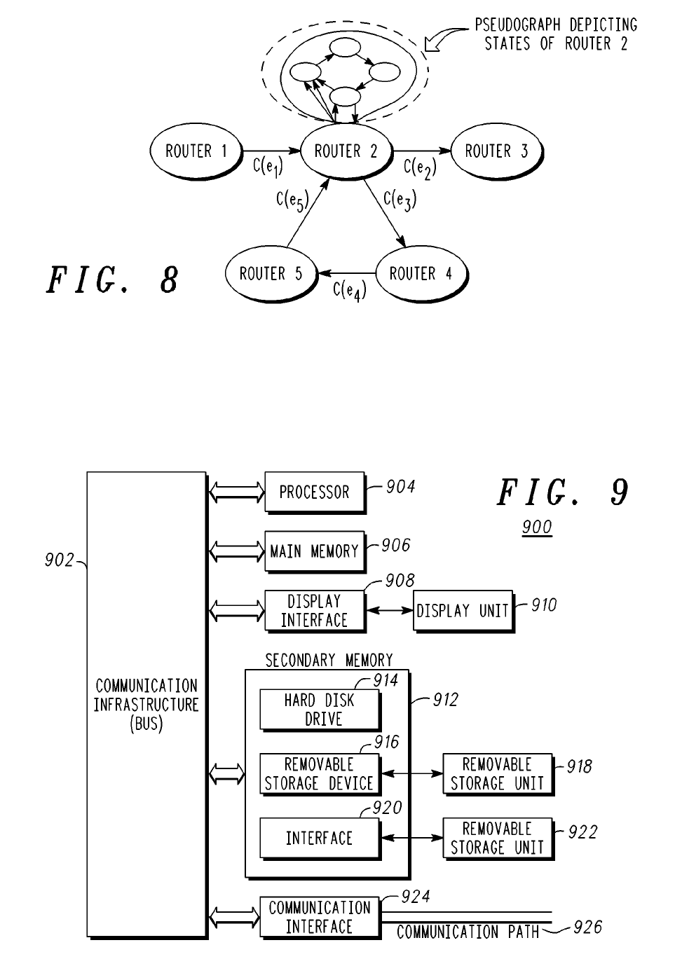

The present invention, according to an additional embodiment, implements that which has just been described and goes even further by utilizing the state of multiple managed entities. Hence, instead of nodes being states of a particular managed entity, as represented in FIGS. 3-7, nodes are now the end state of different managed entities. The individual states of each of these managed entities are represented in one or more of a pseudograph, hypergraph, or multigraph, assuming that these individual states are important. In other words, at this level of abstraction, as represented in FIG. 8, only the final state of five routers, Router 1-Router 5, is important, not the set of additional states that each router transitions to.

In this embodiment, policies are applied in the same way as before, except that they are being applied at a different level of abstraction. However, if the desired final state of, for example, router 2, is not what it should be, then the invention allows the process to go into the management (e.g., transition into the dashed ellipse) of router 2 and use the same policy management approach to manage it to force the router back to the desired state. Hence, what is created is a system for controlling policies at both a macro level (the router-router level) and micro level (the individual states of any given router).

Policy Server

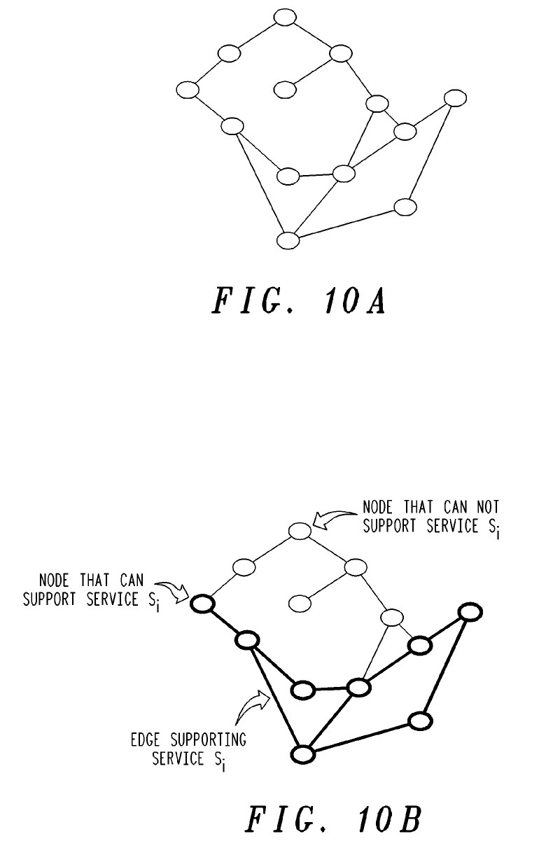

FIG. 9 is a high level block diagram illustrating a detailed view of a computing system 900 useful for implementing the policy server 102 according to embodiments of the present invention. The computing system 900 is based upon a suitably configured processing system adapted to implement an exemplary embodiment of the present invention. For example, a personal computer, workstation, or the like, may be used.

In one embodiment of the present invention, the computing system 900 includes one or more processors, such as processor 904. The processor 904 is connected to a communication infrastructure 902 (e.g., a communications bus, crossover bar, or network). Various software embodiments are described in terms of this exemplary computer system. After reading this description, it will become apparent to a person of ordinary skill in the relevant art(s) how to implement the invention using other computer systems and/or computer architectures.

The computing system 900 can include a display interface 908 that forwards graphics, text, and other data from the communication infrastructure 902 (or from a frame buffer) for display on the display unit 910. The computing system 900 also includes a main memory 906, preferably random access memory (RAM), and may also include a secondary memory 912 as well as various caches and auxiliary memory as are normally found in computer systems. The secondary memory 912 may include, for example, a hard disk drive 914 and/or a removable storage drive 916, representing a floppy disk drive, a magnetic tape drive, an optical disk drive, etc. The removable storage drive 916 reads from and/or writes to a removable storage unit 918 in a manner well known to those having ordinary skill in the art. Removable storage unit 918, represents a floppy disk, a compact disc, magnetic tape, optical disk, etc. which is read by and written to by removable storage drive 916. As will be appreciated, the removable storage unit 918 includes a computer readable medium having stored therein computer software and/or data. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer-readable information.

In alternative embodiments, the secondary memory 912 may include other similar means for allowing computer programs or other instructions to be loaded into the policy server 102. Such means may include, for example, a removable storage unit 922 and an interface 920. Examples of such may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to the computing system 900.

The computing system 900, in this example, includes a communications interface 924 that acts as an input and output and allows software and data to be transferred between the policy server 102 and external devices or access points via a communications path 926. Examples of communications interface 924 may include a modem, a network interface (such as an Ethernet card), a communications port, a PCMCIA slot and card, etc. Software and data transferred via communications interface 924 are in the form of signals which may be, for example, electronic, electromagnetic, optical, or other signals capable of being received by communications interface 924. The signals are provided to communications interface 924 via a communications path (i.e., channel) 926. The channel 926 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 906 and secondary memory 912, removable storage drive 916, a hard disk installed in hard disk drive 914, and signals. The computer program products are means for providing software to the computer system. The computer readable medium allows the computer system to read data, instructions, messages or message packets, and other computer readable information from the computer readable medium.

Computer programs (also called computer control logic) are stored in main memory 906 and/or secondary memory 912. Computer programs may also be received via communications interface 924. Such computer programs, when executed, enable the computer system to perform the features of the present invention as discussed herein. In particular, the computer programs, when executed, enable the processor 904 to perform the features of the computer system.

### CONCLUSION

As should now be clear embodiments of the present invention provide an efficient method of determining a best ordering of policies to implement a service hosted on multiple resources or services (this latter takes into account service composition). It represents resources and services to be managed as a graph or set of graphs, and shows their dependency through either nested graphs or a set of multigraphs, pseudographs and/or hypergraphs. The relationships between resources and services to be managed are defined by an information model and bound by one or more data models, ensuring extensibility, agility to add/remove capabilities, and to use code generation facilities to generate configuration code dynamically. The same information model is used to represent policies, thereby establishing inherent relationships between policies, services, and resources. The invention represents policies as a weighting function that can modify the cost of each of the edges of the graph. The actions of a policy are represented by a weighting function, which can be used to modify the cost of an edge. This can be used to establish an initial ordering as well as to subsequently reorder policies according to one or more metrics. The actions of a policy can be used to define if a state change is permissible or not. The actions can also be used to define if one state change is preferred over other state changes, which enables fine-grained control of the state of the system and the states of its components. The initial state change that triggers the application of policy can be modeled by this system. In addition, the subsequent state changes that are desired can be modeled by this system. Furthermore, embodiments of the invention enable simulation of a large variety of states and/or combinations of policies by varying the weighting function of the policies. The invention enables the system to adapt to changing user needs and/or environmental conditions by changing the weighting function of the policies. This invention also enables the system to adapt to context changes (e.g., by changing its resources and services offered) by changing the weighting function of the policies.

### NON-LIMITING EXAMPLES

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for managing state changes of a managed entity, the method comprising:
representing each state change of a managed entity as a separate node in a graph;
representing a state transition as an edge connecting a first node with a first state value to a second node with a second state value; and
determining a cost of each edge that is part of a set of edges that form at least two paths connecting the first node and the second by applying at least one policy to each edge, the first and second nodes representing an initial and a final state change of the managed entity.

2. The method according to claim 1, further comprising:
comparing a total cost of a first one of the at least two paths to a total cost of a second one of the at least two paths; and
selecting one of the at least two paths having a lowest cost.

3. The method according to claim 1, wherein a first policy is related to at least one second policy so that at least one of creating, invoking, deleting, adding, stopping and changing the second policy affects the first policy by causing it to assign a different cost to the set of edges that it governs.

4. The method according to claim 1, further comprising:
setting a weight for the edge by using a parameterized function.

5. The method according to claim 4, wherein:
the determining of a cost of each edge is based on the weight which has been set for that edge.

6. The method according to claim 4, further comprising:
altering the weight of an edge by applying one or more additional policies to the edge.

7. The method according to claim 1, further comprising:
setting a weight for at least one additional edge by using a parameterized function;
comparing the altered weight of the edge to the weight of the additional edge; and
in response to the comparing, selecting one of the edges based on the weight that has been set for that edge.

8. The method according to claim 1, further comprising:
invoking a policy; and
determining a permissibility of a state change by utilizing the policy.

9. The method of claim 1, further comprising:
setting the cost of an edge to a value that removes it from a class of best paths in response to a state change not being allowed by the policy.

10. The method according to claim 1, further comprising:
defining a mathematical function that assigns a cost to an edge governed by Policy;
the inputs to the function being the conventional cost of the edge and the one or more policy-defined weights;
the function being defined by any appropriate means, including (but not limited to) an administrator, metadata in the one or more Policies, or another Policy.

11. A method for managing the connectivity and communication between nodes of a graph, the method comprising:
representing each state change of a managed entity as a separate node in a graph;
representing at least one of the separate nodes as one of either a multigraph, a hypergraph, and a pseudograph of different states of a set of managed entities;
representing a state transition as an edge connecting a first of the separate nodes having a first state value to a second of the separate nodes having a second state value; and
determining a cost of each edge that is part of a set of edges that form at least two paths connecting the first node and the second by applying at least one policy to each edge, the first and second nodes representing an initial and a final state change of the managed entity.

12. The method according to claim 11, further comprising:
comparing a total cost of a first one of the at least two paths to a total cost of a second one of the at least two paths; and
selecting one of the at least two paths having a lowest cost.

13. The method of claim 11, further comprising:
setting the cost of an edge to a value that removes it from a class of best paths in response to a state change not being allowed by the policy.

14. A device for managing state changes of a managed entity, the device comprising:
a memory adapted to store:
managed entity state change information; and
computer executable instructions; and
a processor communicatively coupled to the memory, the processor adapted to:
read the computer executable instructions;
represent each state change of a managed entity as a separate node in a graph;
represent a state transition as an edge connecting a first node with a first state value to a second node with a second state value; and
determine a cost of each edge that is part of a set of edges that form at least two paths connecting the first node and the second by applying at least one policy to each edge, the first and second nodes representing an initial and a final state change of the managed entity.

15. The device according to claim 14, wherein the processor is further adapted to:
compare a total cost of a first one of the at least two paths to a total cost of a second one of the at least two paths; and
select one of the at least two paths having a lowest cost.

16. The device according to claim 14, wherein a first policy is related to at least one second policy so that at least one of invoking, deleting, adding, stopping and changing the second policy affects the first policy by causing it to assign a different cost to the set of edges that it governs.

17. The device according to claim 14, wherein the processor is further adapted to:
set a weight for the edge by using a parameterized function.

18. The device according to claim 17, wherein:
the cost of each edge is based on the weight which has been set for that edge.

19. The device according to claim 18, wherein the processor is further adapted to:
alter the weight of an edge by applying one or more additional policies to the edge.

20. The device according to claim 14, wherein the processor is further adapted to:
set a weight for at least one additional edge by using a parameterized function;
compare the altered weight of the edge to the weight of the additional edge; and
in response to the comparing, selecting one of the edges based on the weight that has been set for that edge.
